(19) United States
(12) Patent Application Publication
(10) Pub. No.: US 2010/0251099 A1
(43) Pub. Date: Sep. 30, 2010

(54) Schema Validation for Submissions of Digital Assets for Network-Based Distribution

(76) Inventors: David Makower, Milpitas, CA (US); Juan Carlos Jimenez, Campbell, CA (US)

Correspondence Address: TI Law Group, 2055 Junction Avenue, #205, San Jose, CA, 95131-2116, US

(21) Appl. No.: 12/412,161

(22) Filed: Mar. 26, 2009

(51) Int. Cl. G06F 17/30; G06F 11/07; G06F 17/00; G06N 5/02

(52) U.S. Cl. 715/237; 714/48; 706/47; 707/E17.005; 714/E11.025

(57) ABSTRACT

Methods and systems for validating digital asset submissions to a network-based digital asset distribution site are disclosed. The validation can be performed in an automated (i.e., computer-implemented) manner at the network-based digital asset distribution site. In one embodiment, the validation of digital asset submissions can include at least schema validation, such as multi-pass schema validation. Upon successful validation, the corresponding digital asset submissions can be made available for online purchase and distribution.

### BACKGROUND OF THE INVENTION

1. Field of the Invention

The present invention relates to electronic submission of digital assets for network-based distribution and, more particularly, to schema validation for electronic submissions of digital assets to network-based distribution system.

2. Description of the Related Art

Today, various online media hosting sites permit virtual visitors to purchase and download albums, songs, movies or applications via the Internet (e.g., World Wide Web). However, in order for the albums, songs, movies or applications to be offered for purchase and download, the electronic content for the albums, songs, movies or applications must first be provided to the media hosting sites. Historically, in the case of songs, a music label desirous of selling audio productions of their songs online produces a tape or CD and then physically mails the tape or CD to a representative for the media hosting site. More recently, music labels have electronically transmitted the audio production of their songs to the media hosting site. Typically, a submission would include not only the audio productions of the songs but also text and images associated with the songs. The text provides descriptive information (e.g., metadata) for the songs and the images pertain to associated artwork (e.g., cover art).

With popular media hosting sites, there are numerous submissions from many different providers. For quality reasons, the submission should be validated before being accepted by the media hosting sites. One type of computer-implemented validation that can be performed is schema validation, which examines whether a particular submission conforms to a set of constraints governing the content of the submission, including allowed and disallowed elements, structural constraints regarding the relationships of one element to another, and constraints on the format of individual data elements. If the submission is successfully validated, i.e., meaning that it conforms to the schema, then the submission is accepted by the media hosting site. On the other hand, if the submission is not able to be validated, then the submission is declined by the media hosting site. Unfortunately, schemas change over time and thus require that submitters also change their practices over time so as to continue to satisfy the current schema.

Thus, there is a need for approaches to facilitate validation of submissions to an online media hosting site.

### SUMMARY OF THE INVENTION

Methods and systems for validating digital asset submissions to a network-based digital asset distribution site are disclosed. In one embodiment, the validation performed includes at least schema validation. The validation can be performed in an automated (i.e., computer-implemented) manner at the network-based digital asset distribution site. Upon successful validation, the corresponding digital asset submissions can be made available for online purchase and distribution.

In one embodiment, validation of digital asset submissions can perform at least a multi-pass schema validation. Here, a digital asset package, such as a digital media package, can be processed to perform schema validation against two or more schemas. By use of two or more schemas, a digital asset package can be evaluated against multiple schemas. For example, one of the schemas can be more strict and another of the schemas can be more forgiving. The digital asset package being submitted can be accepted if it satisfies a looser schema even if it does not satisfy a more rigid schema, though warnings can be provided to alert the submitter of schema adjustments that should be considered.

In one embodiment, a digital asset package at least metadata, distribution information, owner information, and pricing information. The digital asset package can also include digital content pertaining to one or more digital assets. The digital assets can, for example, pertain to digital media such as albums, songs, movies or applications (i.e., computer programs).

The invention can be implemented in numerous ways, including as a method, system, device, or apparatus (including graphical user interface and computer readable medium). Several embodiments of the invention are discussed below.

As a computer-implemented method for validating digital asset packages submitted to a network-based distribution system, one embodiment of the invention can, for example, include at least the acts of: receiving a submission request from a submitter, the submission request including at least a digital asset package; determining whether the digital asset package satisfies a less stringent schema; accepting the digital asset package at the network-based distribution system if it is determined that the digital asset package satisfies the less stringent schema; determining whether the digital asset package satisfies a more stringent schema; and providing a warning to the submitter if it is determined that the digital asset package does not satisfy the more stringent schema.

As a schema validation system, one embodiment of the invention can, for example, include at least: a first set of schema rules; a second set of schema rules; and a schema validation module. The schema validation module being configured to receive a submitted digital asset package having data provided in a structured format, to compare the structured format of the data of the submitted digital asset with both the first set of schema rules and the second set of schema rules, and to validate the structured format of the data based on the comparison of the structured format of the data of the submitted digital asset with both the first set of schema rules and the second set of schema rules.

As a method for performing schema validation, one embodiment of the invention can, for example, include at least the acts of: maintaining a base schema including at least a plurality of schema rules, wherein certain of the plurality of schema rules are mandatory and others are optional; deriving a first set of schema rules and a second set of schema rules from the base schema; and performing schema validation on a submitted digital asset package using the first set of schema rules and the second set of schema rules.

As a computer readable medium including at least computer program code executable by a computer stored thereon, one embodiment of the invention can, for example, include at least: computer program code for receiving a submission request from a submitter, the submission request including at least a digital asset package; computer program code for determining whether the digital asset package satisfies a first schema; computer program code for accepting the digital asset package at the network-based distribution system if the digital asset package satisfies the first schema; computer program code for determining whether the digital asset package satisfies a second schema; and computer program code for providing a warning to the submitter if the digital asset package does not satisfy the second schema.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a media submission and distribution system according to one embodiment of the invention.

FIG. 2 is a block diagram of a submission validation manager according to one embodiment of the invention.

FIG. 3 is a block diagram of a digital asset submission manager according to one embodiment of the invention.

FIG. 4 is a block diagram of a dynamic schema generation system according to one embodiment of the invention.

FIG. 5 is a flow diagram of a media submission process according to one embodiment of the invention.

FIG. 6 illustrates a flow diagram of a schema validation process according to one embodiment of the invention.

FIG. 7 shows an exemplary computer system suitable for use with at least one embodiment of the invention.

### DETAILED DESCRIPTION OF THE INVENTION

Methods and systems for validating digital asset submissions to a network-based digital asset distribution site are disclosed. In one embodiment, the validation performed includes at least schema validation. The validation can be performed in an automated (i.e., computer-implemented) manner at the network-based digital asset distribution site. Upon successful validation, the corresponding digital asset submissions can be made available for online purchase and distribution.

In one embodiment, validation of digital asset submissions can perform at least a multi-pass schema validation. Here, a digital asset package, such as a digital media package, can be processed to perform schema validation against two or more schemas. By use of two or more schemas, a digital asset package can be evaluated against multiple schemas. For example, one of the schemas can be more strict and another of the schemas can be more forgiving. The digital asset package being submitted can be accepted if it satisfies a looser schema even if it does not satisfy a more rigid schema, though warnings can be provided to alert the submitter of schema adjustments that should be considered.

In one embodiment, a digital asset package at least metadata, distribution information, owner information, and pricing information. The digital asset package can also include digital content pertaining to one or more digital assets. The digital assets can, for example, pertain to digital media such as albums, songs, movies or applications (i.e., computer programs).

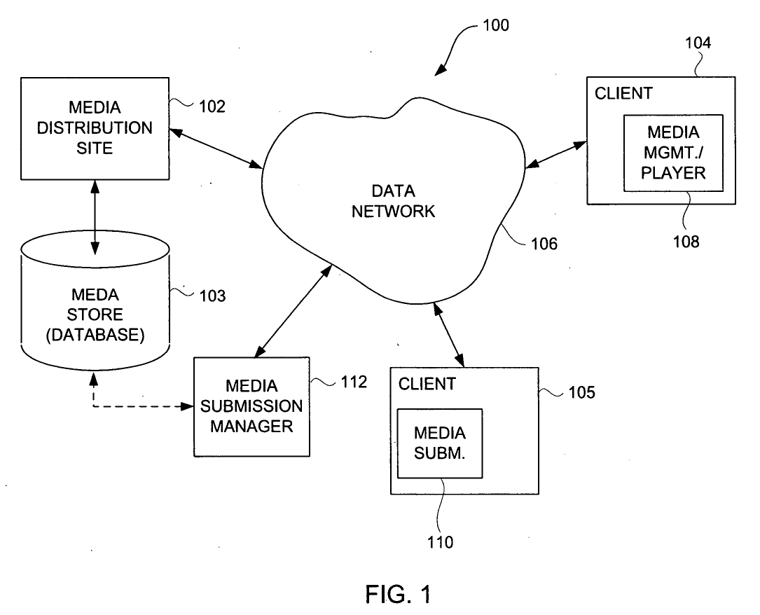

Embodiments of the invention are discussed below with reference to FIGS. 1-7. However, those skilled in the art will readily appreciate that the detailed description given herein with respect to these figures is for explanatory purposes as the invention extends beyond these limited embodiments.

FIG. 1 is a block diagram of a media submission and distribution system 100 according to one embodiment of the invention. The media submission and distribution system 100 includes a media distribution site 102. The media distribution site 102 coordinates submission (receipt), resubmission, storage and download of media items. The media distribution site 102 accesses media items in a media store 103. In one embodiment, the media store 103 is a database. The media store 103 provides mass storage of the numerous media items that are available for download. The media items can be accessed from the media store 103 and downloaded over a data network 106 by way of the media distribution site 102.

The media submission and distribution system 100 also includes a first client 104 and a second client 105. Typically, the media submission and distribution system 100 would include a plurality of different clients 104, 105. The first client 104 includes a media management/player 108. The second client 105 includes a media submission program 110. Some clients can also include both the media management/player 108 and the media submission program 110. The media management/player 108 is an application program (e.g., software application) that operates on the first client 104, which is a computing device. One example of a suitable media management/player 108 is iTunes™ offered by Apple Inc. The first client 104 is coupled to the media distribution site 102 through the data network 106. Hence, any of the first clients 104 can interact with the media distribution site 102 to review, download and/or manage media items.

The media submission program 110 is also an application program (e.g., software application) that operates on the second client 105, which is a computing device. One example of a suitable media submission program is iTunes Producer™ offered by Apple Inc. The media submission program 110 is used to submit (or resubmit) media items to the media distribution site 102. Although the media management/player 108 and the media submission program 110 are shown in FIG. 1 as separate programs, it should be understood that such programs can be integrated into a single program or reside on the same second client.

The media submission and media distribution system 100 also includes a media submission manager 112. The media submission manager 112 manages the submission of media items for the media submission and media distribution system 100. The media items are submitted to the media submission manager 112 of the media distribution site 102 by way of the media submission program 110. A content provider uses the media submission program 110 to make a media submission to the media submission manager 112. The media items that have been submitted (e.g., via the second client 105) are processed and then stored in the media store 103.

Thereafter, the stored media items are available to be downloaded from the media distribution site 102. In downloading a particular media item, the media distribution site 102 permits the media content for the particular media item to be retrieved from the media store 103 and then delivered (e.g., downloaded) from the media distribution site 102 to the corresponding client 104 through the data network 106. In this regard, the media distribution site 102 obtains the media content corresponding to the particular media item from the media store 103 and downloads such content through the data network 106 to the client 104. The downloaded media content can then be stored on the client 104. In one embodiment, the downloaded media content is encrypted as received at the client 104 but is decrypted and then perhaps re-encrypted before persistent storage on the client 104. Thereafter, the media management/player 108 can present (e.g., play) the media content at the client 104.

The media submission and distribution system 100 allows a user (e.g., end-user) of the client 104 to utilize the media player 108 to browse, search or sort through a plurality of media items that can be downloaded from the media distribution site 102. The media management/player 108 may also allow the user to preview a media clip of the media items. In the event that the user of the media management/player 108 desires to purchase a particular media item, the user (via the media management/player 108) and the media distribution site 102 can engage in an online commerce transaction in which the user pays for access rights to the particular media item. In one embodiment, a credit card associated with the user is credited for the purchase amount of the particular media item.

Moreover, after one or more media items have been submitted to the media distribution site 102 by way of the media submission program 110, the content provider may desire to make one or more changes to the submission. For example, the content provider may desire to alter at least a portion of previously submitted media item data. The media item data can represent media item information and/or alter media content. In one implementation, the media item information can pertain to one or more of media identifiers (e.g., UPC/EAN), metadata (data descriptive of the media), pricing settings, sales authorizations, etc. In one implementation, the media content for a particular digital media item can be provided as an electronic file. For example, a content provider may want to change pricing or sales authorizations for various reasons after the original submission. As another example, a content provider may want to correct an error (e.g., typographical error) in the original submission. As another example, a content provider might want to upgrade the quality of the media content by resubmitting media content of a higher quality (e.g., greater bit rate). In particular, if the current bit rate is 125 thousand bits per second (kbps) which is a lossy encoding, then the media content quality can be upgraded to 256 kbps which is a higher quality encoding. In any case, when the content provider desires to make one or more changes to the prior submission, the media submission program 110 can present the previously submitted media item data so that the content provider can in most cases simply make changes to such data. After the changes have been made, the media submission program 110 can resubmit the corresponding media item such that the media submission manager 112 knows to update at least a portion of the previously submitted media item data with the changed media item data.

In one embodiment, the media submission manager 112 can receive originally submitted media item data and make editorial or other changes for various reasons. These changes can be implemented automatically by a computer system or manually by editors. When such changes have been made at the media submission manager 112, the media submission program 110 no longer stores the current media item data that is used by the media submission manager 112. Hence, prior to making changes to the previously submitted media item data, the media submission program 110 can receive from the media submission manager 112 any changes that have already taken place at the media submission manager 112 since the original submission of the media item data. In other words, the media submission program 110 can receive the current media item data from the media submission manager 112 prior to the content provider making changes to the media item data for resubmission. The providing of the current media item data back to the media submission program 110 can be referred to as a synchronization operation whereby media item data between the media submission program 110 and the media submission manager 112 can be kept up-to-date.

The submission (including resubmission) and purchase of the media items can be achieved over a data network 106. In other words, the submission and download of the media items can be achieved online. In one embodiment, the data network 106 includes at least a portion of the Internet. The clients 104 can vary with application but generally are computing devices that have memory storage. Often, the clients 104 are personal computers or other computing devices that are capable of storing and presenting media to their users.

The connections through the data network 106 between the media distribution server 102 and the clients 104, 105 can be through secure connections, such as Secure Sockets Layer (SSL). Further, the media content can be re-encrypted prior to storage at the client 104 such that downloaded media content is not stored in the clear, but is instead stored in an encrypted manner.

Although FIG. 1 is described with respect to the submission and distribution of media, such as media items, it should be notes that the media submission and media distribution system 100 is more generally applicable to the submission and distribution of digital assets. The digital assets can, for example, pertain to (i) digital media such as albums, songs, audiobooks, movies or media-based applications (e.g., games), and (ii) non-media-based applications (i.e., other computer programs).

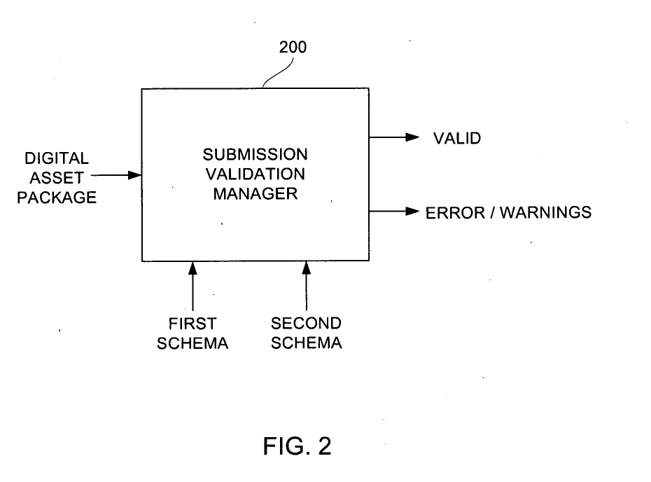

FIG. 2 is a block diagram of a submission validation manager 200 according to one embodiment of the invention. The submission validation manager 200 can, for example, represent at least a portion of the media submission manager 112 illustrated in FIG. 1. Hence, at least one objective for the media submission manager 112 is to perform validation of a submission of a digital asset package. Accordingly, the submission validation manager 200 receives a digital asset package that has been submitted by a submitter (e.g., content provider). In one implementation, the digital asset package can have an eXtensible Markup Language (XML) format. The submission validation manager 200 can also include or have access to multiple schema, such as a first schema and a second schema as illustrated in FIG. 2. The first schema can be considered a strict schema or a mandatory schema, while the second schema can be considered a transitory schema or an optional schema. The first schema and the second schema are typically described in a markup language format stored in an electronic file, such as an XML file. In other words, the first schema and the second schema can be considered schema rules or schema definitions. The submission validation manager 200 operates, such as a computing device (e.g., server computer), to evaluate at least a portion of the digital asset package with respect to the requirements, whether mandatory or optional, imposed in the first schema and the second schema. Based on the evaluation of the digital asset package with respect to the first schema and the second schema, the submission validation manager 200 can determine whether the submission is to be deemed valid (or invalid) as well as whether any schema warnings or schema errors are to be provided to the submitter. For example, the schema validation manager 200 can issue an error notification if the digital asset package is not able to satisfy the requirements imposed by the first schema. As another example, the schema validation manager can issue a warning notification if the digital asset package does not satisfy at least a portion of the requirement imposed by the second schema (but does satisfy the requirements imposed by the first schema). The warning notification can specify those one or more portions of the digital asset package that do not satisfy the requirements of the second schema.

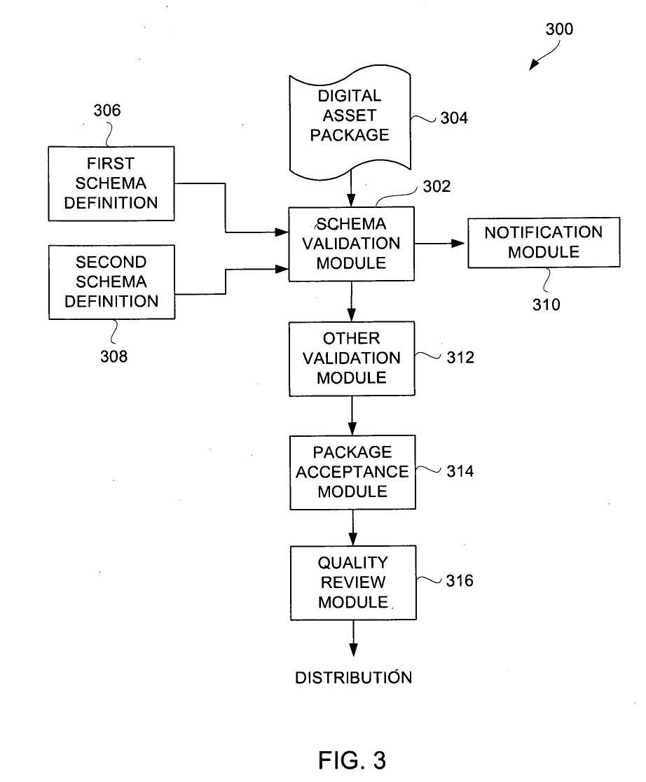

FIG. 3 is a block diagram of a digital asset submission manager 300 according to one embodiment of the invention. The digital asset submission manager 300 is, for example, one embodiment for the media submission manager 112 illustrated in FIG. 1.

The digital asset submission manager 300 includes a schema validation module 302. The schema validation module 302 receives a digital asset package 304. The schema validation module 302 also has access to a first schema definition 306 and a second schema definition 308. During operation, the schema validation module 302 can operate to validate the schema utilized by the digital asset package 304 against the first schema definition 306 and the second schema definition 308. In one embodiment, the schema validation module 302 can be considered to implement a multi-pass validation, since the digital asset package 304 can be validated against not only the first schema definition 306 but also the second schema definition 308.

The schema validation module 302 can determine whether the schema associated with the digital asset package 304 are deemed valid. The schema validation module 302 can also provided a notification to a submitter of the digital asset package 304. The notification can indicate whether the digital asset package has been successfully validated or has failed validation. Besides success or failure, the notification can specify what schema errors exist and/or can provide warnings where the schema can be improved. For example, the warnings can indicate where and/or how the submission can be improved or made to comply more closely with pre-established specifications set forth by a media hosting site.

In one embodiment, the first schema definition 306 can indicate current schema requirements, and the second schema definition 308 can indicate future schema requirements. Hence, if the digital asset package 304 satisfies the first schema definition 306 but not the second schema definition 308, the digital asset package 304 is able to be validated but the submitter receives a notification informing them that in certain instances the schema for the digital asset package 304 does not satisfy the second schema definition 308. As a consequence, the submitter is informed about a need to keep the schema for the digital asset package 304 up-to-date with the digital asset submission manager 300. This alerts the submitter that the schema has been improved, enhanced or evolved over time. For example, the warnings provide feedback to the submitter that they will need to update the schema for submissions of digital asset packages as some time in the future. As one example, the second schema definition 308 can in the future become a first schema definition. As another example, one or more individual rules from the stricter schema can in the future become part of the less strict schema, such that violations of those one or more individual rules cease to become warning and become errors instead. Advantageously, the submitter is provided with advance notice of situations in which they will likely need to update the schema they in the future provide with their submissions of digital asset packages.

The digital asset submission manager 300, besides schema validation, can perform other validations with respect to the digital asset package using an other validation module 312. The other validation module 312 can validate other aspects of the digital asset package 304, including size, content, encoding, etc. The digital asset submission manager 300 can also include a package acceptance module 314 and a quality review module 316. The digital asset package 304, after successful schema validation (and other possible validations), can be provided to the package acceptance module 314. The package acceptance module 314 can be configured to accept the digital asset package 304. This can cause the one or more digital assets of the digital asset package 304 to be received and stored by the digital asset submission manager 300. Prior thereto, the digital asset submission manager 300 can, in one embodiment, prevent receipt of the one or more digital assets until the digital asset package 304 is validated.

The quality review module 316 can be configured to manage quality review for the one or more digital assets associated with or internal to the digital asset package 304. The quality review can be manually performed, automatically performed, or some combination of the two. The quality review can also differ depending upon the type of media being submitted. After the quality review by the quality review module 316, assuming that the quality review has deemed the one or more digital assets to have sufficient quality, the digital asset package 10 can then become available for distribution over a network. For example, the digital asset package 304 can be rendered available for distribution by a network-based digital asset distribution site, such as for example the media distribution site 102 illustrated in FIG. 1. Still further, in one embodiment, the quality review module 316 can operate to evaluate the quality of one or more digital assets using quality review rules, and by providing multiple set of quality review rules, quality results with varying severity can be provided.

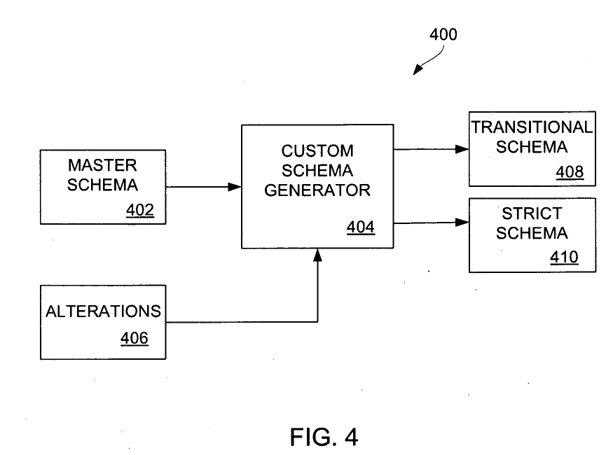

FIG. 4 is a block diagram of a dynamic schema generation system 400 according to one embodiment of the invention. The dynamic schema generation process 400 can include a master schema 402. The master schema 402 refers to a base schema that can be supplied to a custom schema generator 404. The custom schema generator 404 also receives alterations 406 that can be used by the custom schema generator 404 utilized to alter the master schema 402 to yield one or more custom schema. For example, as shown in FIG. 4, the custom schema generator 404 can alter the master schema 402 in accordance with the alterations 406 to produce a transitional schema 408 and a strict schema 410. The master schema 402 is a central schema description that can include optional schema rules as well as mandatory schema rules. By altering the master schema 402, the transitional schema 408 can be obtained. Similarly, by altering the master schema 402, the strict schema 410 can be obtained. In other words, the transitional schema 408 and/or the strict schema 410 can be dynamically produced from the master schema 402.

In one embodiment, the custom schema generator 404 can generate different schemas for different content providers. For example, though use of the alterations 406 or other input to the custom schema generator, different sets of rules can be applied for different content providers. For example, based on contracts with content providers, one content provider may be able to specify that some of their content may be sold with digital rights management, while other content providers may not be allowed to specify the element that requires digital rights management on a given product.

The schemas can be described or defined using a markup language. A markup language is able to be parsed and evaluated by a computing device. Hence, schema validation can be performed in an automated manner by describing or defining schemas using a markup language. One suitable markup language is XML.

Immediately below are simplified examples of a transitional schema and a strict schema according to one embodiment of the invention. These examples describe or define the exemplary schemas using XML.

First, the exemplary strict schema is provided for media submissions that pertain to albums having tracks.

Exemplary Strict Scheme

```
<?xml version=“1.0” encoding=“UTF-8”?>
<grammar xmlns=“http://relaxng.org/ns/structure/1.0”
datatypeLibrary=“http://www.w3.org/2001/XMLSchema-datatypes”
ns=“http://apple.com/itunes”>
  <start>
    <element name=“album”>
      <element name=“title”>
        <text/>
      </element>
      <element name=“artist”>
        <text/>
      </element>
      <element name=“release_date”>
        <data type=“date”/>
      </element>
      <element name=“tracks”>
        <oneOrMore>
          <element name=“track”>
            <element name=“title”>
              <text/>
            </element>
            <optional>
              <element name=“artist”>
                <text/>
              </element>
            </optional>
          </element>
        </oneOrMore>
      </element>
    </element>
  </start>
</grammar>
```

Second, the exemplary transitional schema is also provided for media submissions that pertain to albums having tracks. The exemplary transitional schema is less stringent than the exemplary strict schema.

Exemplary Transitional Scheme

```
<?xml version=“1.0” encoding=“UTF-8”?>
<grammar xmlns=“http://relaxng.org/ns/structure/1.0”
datatypeLibrary=“http://www.w3.org/2001/XMLSchema-datatypes”
ns=“http://apple.com/itunes”>
  <start>
    <element name=“album”>
      <choice>
        <element name=“title”>
          <text/>
        </element>
        <!-- Transitional change: The <name> element is deprecated,
and <title> should be used instead. -->
        <element name=“name”>
          <text/>
        </element>
      </choice>
      <optional>
        <!-- Transitional change: The <artist> element is optional at the
<album> level. -->
        <element name=“artist”>
          <text/>
        </element>
      </optional>
      <element name=“release_date”>
        <!-- Transitional change: Dates can be spelled-out in English
like: March 1st, 2009. -->
        <text/>
      </element>
      <element name=“tracks”>
        <oneOrMore>
          <element name=“track”>
            <element name=“title”>
              <text/>
            </element>
            <optional>
              <element name=“artist”>
                <text/>
              </element>
            </optional>
          </element>
        </oneOrMore>
      </element>
    </element>
  </start>
</grammar>
```

Further, as discussed above with respect to FIG. 4, the strict schema and/or the transitional schema can be derived from a master schema (or base schema). In one embodiment, the strict schema is the master schema. In any case, in one embodiment, the transitional schema can be derived from the master schema through alteration rules (or alteration instructions),

Immediately below are simplified examples of alteration rules according to one embodiment of the invention. These exemplary alteration rules serve to describe alterations made to the strict schema to produce the transitional schema. The specific alterations described by these exemplary alteration rules are: (i) permit an element “title” to be interchangeable with element “name”, (ii) make the element “artist” optional, and (iii) permit “release date” to have a spelled-out textual format. These specific alterations are contained in an alterations file and describe or define the exemplary alteration rules using XML.

Exemplary Alteration Rules

```
<?xml version=“1.0” encoding=“UTF-8”?>
<a:alterations xmlns:xs=“http://www.w3.org/2001/XMLSchema”
xmlns:a=“http://apple.com/jingle/importer/xml/alteration/xmlbeans”>
<!-- Make <title> interchangeable with the deprecated <name> element. --
>
  <a:replace_node
path=“/grammar/start/element[@name=‘album’]/
element[@name=‘title’]”>
    <choice>
      <element name=“title”>
        <text/>
      </element>
      <!-- Transitional change: The <name> element is deprecated, and
<title> should be used instead. -->
      <element name=“name”>
        <text/>
      </element>
    </choice>
  </a:replace_node>
<!-- Make the <artist> element optional. -->
  <a:replace_node
path=“/grammar/start/element[@name=‘album’]/
element[@name=‘artist’]”
>
    <!-- Transitional change: The <artist> element is optional at the
<album> level. -->
    <optional>
      <element name=“artist”>
        <text/>
      </element>
    </optional>
  </a:replace_node>
<!-- Make <release_date> allow English text instead of just a YYYY-
MM-DD format -->
  <a:replace_node
path=“/grammar/start/element[@name=‘album’]/
element[@name=‘release_date’]/data”>
    <!-- Transitional change: Dates can be spelled-out in English like:
March 1st, 2009. -->
    <text/>
  </a:replace_node>
</a:alterations>
```

These exemplary alteration rules are described using an XML transformation language. Alternatively, a XSLT transformation language which is more complicated could be used to describe these exemplary alteration rules.

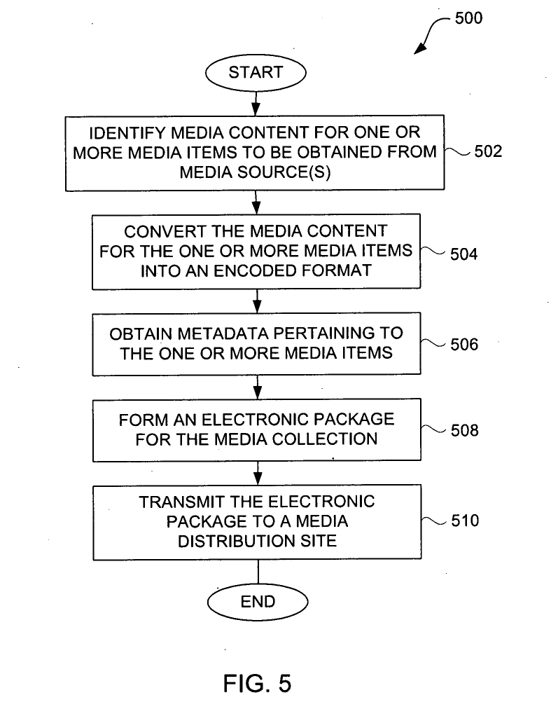

FIG. 5 is a flow diagram of a media submission process 500 according to one embodiment of the invention. The media submission process 500 is typically performed by a client machine, such as the client 105 illustrated in FIG. 1. More particularly, the media submission program 110 at the client 105 illustrated in FIG. 1 can perform the media submission process 500.

The media submission process 500 begins with identification 502 of media content for one or more media items for submission from a client machine to a server machine (e.g., media distribution site).

Typically, the media content for the identified media items is retrieved from one or more media sources. Examples of media sources are compact discs (CDs) or media files. After the media content has been identified 502, the media content for the one or more media items can be converted 504 into an encoded format. Here, in the case of compact discs, the stored data is in a format that is not suitable for transmission over networks. Hence, typically, the format of the media content from compact disc is converted into an encoded format that is suitable for transmission through networks. Examples of some encoded formats for audio files include Advanced Audio Coding (AAC), Apple Lossless Audio Codec (ALAC), and MPEG (e.g., MP3 and M4A) files. In many cases, the encoding formats provide compression so that transmission is efficient. The compression can be lossy or lossless.

Next, metadata pertaining to the one or more media items can be obtained 506. In one embodiment, the metadata for the one or more media items includes descriptive information regarding the one or more media items. The metadata is, in one embodiment, provided by a content provider through interaction with the client machine (e.g., the media submission program 110).

Thereafter, an electronic package is formed 508 for the media items. The electronic package is, for example, an electronic folder that includes a plurality of files. The plurality of files within the electronic folder can include a file for the media content (in its compressed format) for each of the one or more media items, folder metadata, and possibly other files. Here, the folder metadata can include not only the metadata for the media items, but also other metadata pertaining to a media collection and/or an organization of the electronic folder and components within the electronic folder. An example of one type of other file would be a file of an image that is to be associated with the one or more media items or the media collection. The image, for example, can pertain to artwork. An example of another type of other file would be a file containing liner notes to be associated with the media collection. After the electronic package has been formed 508, the electronic package can be transmitted 510 to a media distribution site (e.g., server) for validation, review and distribution. For example, the electronic package can be transmitted 510 to a media submission server, such as the media submission server 112 illustrated in FIG. 1. The transmission 510 of the electronic package to the media distribution site concludes the media submission process 500.

Advantageously, the electronic packages being formed and transmitted to a media distribution site can have a standard format and arrangement. As a result, the media distribution site is able to process the incoming electronic packages in an automated manner. Although FIG. 5 is described with respect to the submission of an electronic package pertaining to media items, it should be understood that the processing similar to the media submission process 500 can be used to submit other digital assets that are non-media-based.

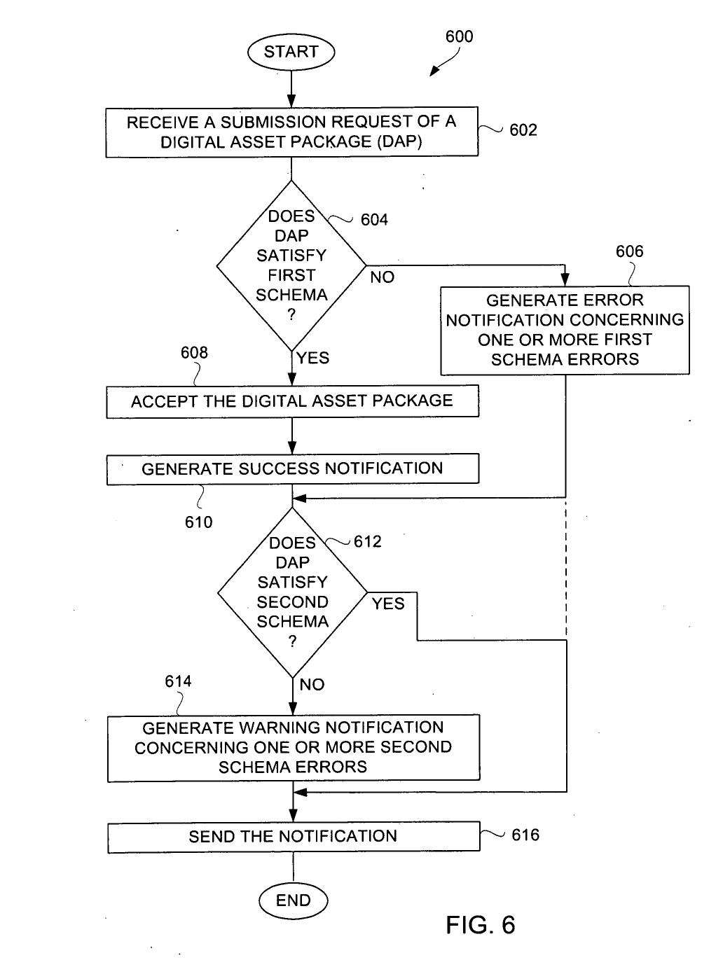

FIG. 6 illustrates a flow diagram of a schema validation process 600 according to one embodiment of the invention. The schema validation process 600 can, for example, be performed by a media submission manager, such as the media submission manager 112 illustrated in FIG. 1 or the media submission manager 300 illustrated in FIG. 3.

The schema validation process 600 can, for example, receive 602 a submission request of a digital asset package. The submission request can be initiated by a submitter operating a digital asset submission program (e.g., media asset submission program) on a computing device. For example, the submission request can be initiated by a submitter operating the media submission program 110 on the client 105 illustrated in FIG. 1. The submission request operates to submit the digital asset package to the media submission manager. The digital asset package can include various types of metadata and management data requested by the media submission manager. Optionally, the digital asset package can also include digital data pertaining to one or more digital assets associated with the digital asset package.

After the submission request has been received 602, a decision 604 determines whether the digital asset package satisfies a first schema. The first schema is, for example, a plurality of schema rules that the digital asset package must satisfy. When the decision 604 determines that the digital asset package does not satisfy the first schema, then the submission request of the digital asset package is denied because the digital asset package does not satisfy the mandatory requirements of the first schema. Hence, in this case, an error notification concerning one or more first schema errors can be generated 606.

On the other hand, when the decision 604 determines that the digital asset package that has been submitted does satisfy the first schema, the digital asset package is accepted 608. For example, the media submission manager can deem the digital asset package to be acceptable. At this point, the entire digital asset package can have been received by the media submission manager or only a part or description of the digital asset package may have been received. In any case, following the acceptance 608 of the digital asset package, a success notification can be generated 610.

Next, a decision 612 determines whether the digital asset package satisfies a second schema. The second schema pertains to schema rules that are not mandatory, but desired. Hence, when the decision 612 determines that the digital asset package also satisfies the second schema, no additional notification is required. However, in an alternative embodiment, the success notification can be modified and/or a new notification can be generated to inform the submitter that the digital asset package that has been submitted also satisfies the second schema.

On the other hand, when the decision 612 determines that the digital asset package does not satisfy the second schema, a warning notification can be generated 614 concerning one or more second schema errors. At this point, the appropriate notification (or notifications) have been generated, such as in blocks 606, 610 and 614. Hence, the schema validation process 600 can then send 616 the one or more notifications that have been previously generated. Typically, the one or more notifications would be sent to the submitter of the digital asset package. Following the block 616, the schema validation process 600 can end.

It should be noted that following the block 606, the blocks 608 and 610 can be bypassed since the decision 604 determines that the digital asset package does not satisfy the first schema. Further, following the block 606, depending on implementation, the schema validation process 600 can proceed to the decision 612 or can alternatively proceed directly to the block 616.

Immediately below are simplified examples of digital asset packages that could be submitted and then schema validated against a strict schema and a transitional schema, such as the exemplary strict schema and the exemplary transitional schema noted above.

In a first example, the simplified example represents a digital media asset package that is not valid because it does not satisfy the exemplary strict schema.

```
<?xml version=“1.0” encoding=“UTF-8”?>
<album xmlns=“http://apple.com/itunes”>
  <title>Magical Mystery Tour</title>
  <artist>The Bartles</artist>
  <release_date>1967-11-27</release_date>
</album>
```

Here, the digital asset package does not include a <track> element. Since both the exemplary strict schema and the exemplary transitory schema require the <track> element, the digital asset package cannot be validated against either the exemplary strict schema or the exemplary transitory schema. For such an example, the error notification produced and provided to the submitter can include information such as provided in the following exemplary error notification.
Error at line 7 and column 9: The <tracks> element is required under /album.
   The exemplary warning can also be returned to the submitter such that the one or more errors are integrated into the digital asset package (e.g., in-line) so as to reference the location where the problem exists.

In a second example, the simplified example represents a digital asset package that is valid because satisfies the exemplary strict schema. However, since the digital asset package does not also satisfy the exemplary transitional schema, the submitter receives one or more warning notifications.

```
<?xml version=“1.0” encoding=“UTF-8”?>
<album xmlns=“http://apple.com/itunes”>
  <name>Magical Mystery Tour</name>
  <release_date>November 11th, 1967</release_date>
  <tracks>
    <track>
      <title>Magical Mystery Tour</title>
    </track>
    <track>
      <title>The Fool on the Hill</title>
    </track>
    <track>
      <title>Flying</title>
    </track>
    <track>
      <title>Blue Jay Way</title>
    </track>
    <track>
      <title>Your Mother Should Know</title>
    </track>
    <track>
      <title>I Am the Walrus</title>
    </track>
    <track>
      <title>Hello, Goodbye</title>
    </track>
    <track>
      <title>Strawberry Fields Forever</title>
    </track>
    <track>
      <title>Penny Lane</title>
    </track>
    <track>
      <title>Baby, You're a Rich Man</title>
    </track>
    <track>
      <title>All You Need Is Love</title>
    </track>
  </tracks>
</album>
```

Here, the digital asset package is able to be validated against the exemplary transitional schema. However, for several reasons, the digital asset package in this second example does not validate against the exemplary strict schema. First, the digital asset package uses a <name> element but the exemplary strict schema requires use of a <title> element. Second, the digital asset package does not include an <artist> element which is required for the exemplary strict schema but optional form the exemplary transitional schema. Third, the digital asset package uses a release date format that is text (spelled out) which is permitted by the exemplary transitional schema, but not permitted by the exemplary strict schema (which requires a machine-readable date format). For such an example, the warning notification produced and provided to the submitter can include information such as provided in the following exemplary warning notification.
Warning for line 4 and column 8: The <name> element is deprecated, use <title> instead.
Warning for line 7 and column 16: No <artist> tag found in /album.
Warning for line 7 and column 50: The value of <release_date> under /album does not appear to be a machine-readable date.
   The exemplary warning can also be returned to the submitter such that the one or more warnings are integrated into the digital asset package (e.g., in-line) so as to reference the location where the problem exists.

In a third example, the simplified example represents a digital asset package that is fully valid and yields no warnings because it satisfies both the exemplary strict schema and the exemplary transitional schema.

```
<?xml version=“1.0” encoding=“UTF-8”?>
<album xmlns=“http://apple.com/itunes”>
  <title>Magical Mystery Tour</title>
  <artist>The Bartles</artist>
  <release_date>1967-11-27</release_date>
  <tracks>
    <track>
      <title>Magical Mystery Tour</title>
    </track>
    <track>
      <title>The Fool on the Hill</title>
    </track>
    <track>
      <title>Flying</title>
    </track>
    <track>
      <title>Blue Jay Way</title>
    </track>
    <track>
      <title>Your Mother Should Know</title>
    </track>
    <track>
      <title>I Am the Walrus</title>
    </track>
    <track>
      <title>Hello, Goodbye</title>
    </track>
    <track>
      <title>Strawberry Fields Forever</title>
    </track>
    <track>
      <title>Penny Lane</title>
    </track>
    <track>
      <title>Baby, You're a Rich Man</title>
    </track>
    <track>
      <title>All You Need Is Love</title>
    </track>
  </tracks>
</album>
```

Here, the digital asset package is able to be validated against both the exemplary strict schema and the exemplary transitional schema.

Although the embodiment of the invention discussed above primarily involve two schemas, e.g., strict schema and transitional schema, it should be noted that more than two schemas can be similarly processed. In one embodiment, the schemas have a varying degree of strictness which allows errors or warnings of arbitrarily granular severity. Also, the two or more different schemas can provide different degrees of severity, or can be more generally used to validate arbitrarily different dimensions of compliance.

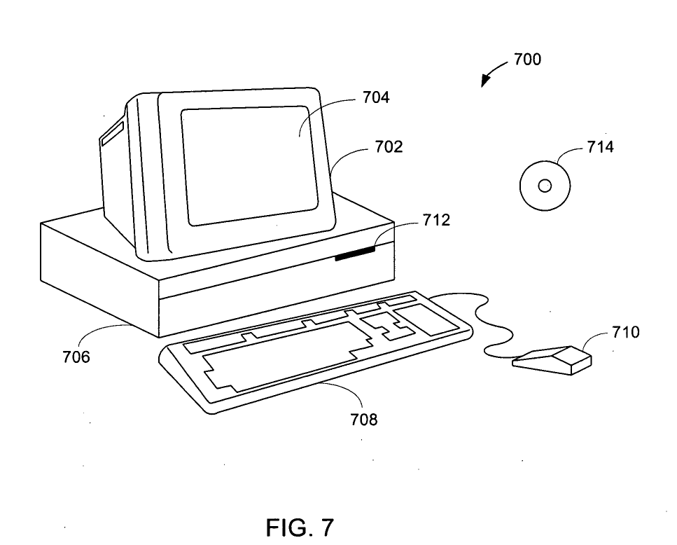

FIG. 7 shows an exemplary computer system 700 suitable for use with at least one embodiment of the invention. The methods, processes, systems and/or graphical user interfaces discussed above can be provided by a computer system. The computer system 700 includes a display monitor 702 having a single or multi-screen display 704 (or multiple displays), a cabinet 706, a keyboard 708, and a mouse 710. The mouse 710 is representative of one type of pointing device. The cabinet 706 houses a processing unit (or processor), system memory and a hard drive (not shown). The cabinet 706 also houses a drive 712, such as a DVD, CD-ROM or floppy drive. The drive 712 can also be a removable hard drive, a Flash or EEPROM device, etc. Regardless, the drive 712 may be utilized to store and retrieve software programs incorporating computer code that implements some or all aspects of the invention, data for use with the invention, and the like. Although CD-ROM 714 is shown as an exemplary computer readable storage medium, other computer readable storage media including floppy disk, tape, Flash or EEPROM memory, memory card, system memory, and hard drive may be utilized. In one implementation, a software program for the computer system 700 is provided in the system memory, the hard drive, the drive 712, the CD-ROM 714 or other computer readable storage medium and serves to incorporate the computer code that implements some or all aspects of the invention.

Additional information on media submission can be found in U.S. Patent Publication No. 2004/0254883 A1; U.S. Patent Publication No. 2007/0083471 A1; U.S. Patent Publication No. 2007/0083471 A1; U.S. Patent Publication No. 2008/0040379 A1, all of which are incorporated herein by reference.

The various aspects, features, embodiments or implementations of the invention described above can be used alone or in various combinations.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different embodiments or implementations may, but need not, yield one or more of the following advantages. One advantage of the invention is that submissions of digital asset packages to online digital asset hosting sites can be validated against multiple schema definitions. Warnings and/or error notifications can inform submitter on schema deficiencies. Another advantage of the invention is that different degrees of schema compliance can be evaluated through use of multiple schemas. For example, a digital asset submission can be accepted at an online digital asset hosting site if it satisfies a less rigorous schema but fails a more rigorous schema. Still another advantage of the invention is that by validating against multiple schema definitions submitters can be informed and assisted with transitioning to new schema definitions.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for validating digital asset packages submitted to a network-based distribution system, said method comprises:
(a) receiving a submission request from a submitter, the submission request including at least a digital asset package;
(b) determining whether the digital asset package satisfies a less stringent schema;
(c) determining whether the digital asset package satisfies a more stringent schema; and
(d) accepting the digital asset package at the network-based distribution system if said determining (b) determines that the digital asset package satisfies the less stringent schema;
(e) providing a warning to the submitter if said determining (c) determines that the digital asset package does not satisfy the more stringent schema.

2. A computer-implemented method as recited in claim 1, wherein said method further comprises:
(f) declining the digital asset package at the network-based distribution system if said determining (c) determines that the digital asset package does not satisfy the less stringent schema.

3. A computer-implemented method as recited in claim 1, wherein the digital asset package is a digital media package.

4. A computer-implemented method as recited in claim 1, wherein the warning comprises an indication of why the digital asset package does not does not satisfy the more stringent schema.

5. A computer-implemented method as recited in claim 1, wherein the warning comprises an indication of at least one error and its position within the digital asset package.

6. A computer-implemented method as recited in claim 1,
wherein the network-based distribution system includes a master schema with certain schema items being mandatory and with other schema items being optional, and
wherein the less stringent schema and the more stringent schema are derived from the master schema.

7. A computer-implemented method as recited in claim 1, wherein the less stringent schema and the more stringent schema are defined in a markup language.

8. A computer-implemented method as recited in claim 1, wherein the markup language comprises XML.

9. A computer-implemented method as recited in claim 1,
wherein the network-based distribution system includes a base schema, and
wherein the less stringent schema is derived from the base schema using at least one alteration rule.

10. A computer-implemented method as recited in claim 1,
wherein the network-based distribution system includes a base schema, and
wherein the more stringent schema is derived from the base schema using at least one alteration rule.

11. A schema validation system, comprising:
a first set of schema rules;
a second set of schema rules; and
a schema validation module configured to receive a submitted digital asset package having data provided in a structured format, to compare the structured format of the data of the submitted digital asset with both the first set of schema rules and the second set of schema rules, and to validate the structured format of the data based on the comparison of the structured format of the data of the submitted digital asset with both the first set of schema rules and the second set of schema rules.

12. A schema validation system as recited in claim 11, wherein the first set of schema rules is a less stringent than the second set of schema rules.

13. A schema validation system as recited in claim 11, wherein said schema validation system further comprises:
a base schema including at least a plurality of schema rules, wherein certain of the plurality of schema rules are mandatory and others are optional, and
wherein the first set of schema rules and the second set of schema rules are derived from the base schema.

14. A schema validation system as recited in claim 13, wherein the first set of schema rules is a less stringent than the second set of schema rules.

15. A schema validation system as recited in claim 12, wherein schema validation module validates the structured format of the data such that (i) the submitted digital asset package is deemed to have a valid schema if the structured format of the data of the submitted digital asset satisfies the first set of schema rules; and (ii) a warning notification is sent concerning the schema of the submitted digital asset package if the structured format of the data of the submitted digital asset does not satisfy the second set of schema rules.

16. A method for performing schema validation, said method comprising:
maintaining a base schema including at least a plurality of schema rules, wherein certain of the plurality of schema rules are mandatory and others are optional;
deriving a first set of schema rules and a second set of schema rules from the base schema; and
performing schema validation on a submitted digital asset package using the first set of schema rules and the second set of schema rules.

17. A method as recited in claim 16,
wherein the submitted digital asset package has data provided in a structured format, and
wherein said performing of the schema validation comprises:
comparing the structured format of the data of the submitted digital asset with both the first set of schema rules and the second set of schema rules; and
validating the structured format of the data based on the comparison of the structured format of the data of the submitted digital asset with both the first set of schema rules and the second set of schema rules,

18. A method as recited in claim 17, wherein the first set of schema rules is a less stringent than the second set of schema rules.

19. A computer readable medium including at least computer program code executable by a computer stored thereon, said computer readable medium comprising:
computer program code for receiving a submission request from a submitter, the submission request including at least a digital asset package;
computer program code for determining whether the digital asset package satisfies a first schema;
computer program code for accepting the digital asset package at the network-based distribution system if said computer program code for determining determines that the digital asset package satisfies the first schema;
computer program code for determining whether the digital asset package satisfies a second schema; and
computer program code for providing a warning to the submitter if said computer program code for determining determines that the digital asset package does not satisfy the second schema.

20. A computer readable medium as recited in claim 19, wherein the first schema is a less stringent schema than the second schema.

21. A computer readable medium as recited in claim 19, wherein said computer readable medium further comprises:
computer program code for declining the digital asset package at the network-based distribution system if said computer program code for determining determines that the digital asset package does not satisfy the less stringent schema.

22. A computer readable medium as recited in claim 19, wherein the digital asset package is a digital media package.
